(19) United States
(12) Patent Application Publication
(10) Pub. No.: US 2025/0277553 A1
(43) Pub. Date: Sep. 4, 2025

(54) FLUID PULSE DAMPER AND BEVERAGE PREPARATION DEVICE

(71) Applicant: Dongguan ZEEWAY-Technology Ltd, Guangdong Province (CN)

(72) Inventors: Mengyi Zhu, Guangdong Province (CN); Fulin Lv, Guangdong Province (CN); Riling Huang, Guangdong Province (CN); Liang Zhou, Guangdong Province (CN); Qiaohuang Li, Guangdong Province (CN); Long Chen, Guangdong Province (CN); Wenchao Deng, Guangdong Province (CN); Qihong She, Guangdong Province (CN)

(73) Assignee: Dongguan ZEEWAY-Technology Ltd, Guangdong Province (CN)

(21) Appl. No.: 18/955,954

(22) Filed: Nov. 21, 2024

(30) Foreign Application Priority Data
Feb. 29, 2024 (CN) 2024203889628

(51) Int. Cl. F16L 55/04; B67D 1/12

(52) U.S. Cl. CPC F16L 55/04; B67D 1/125

(57) ABSTRACT

The present disclosure discloses a fluid pulse damper. It comprises a damper body and a top cover, the top cover being combined with the damper body to define a closed chamber, with an inlet and an outlet into the closed chamber provided at opposite ends of the damper body; and a damper block, being provided on a bottom wall of the closed chamber, and being shaped so that fluid entering from the inlet is divided into a number of diffuse diversions and the diffuse diversions converge in proximity to the outlet and then flow out from the outlet. The disclosure also discloses a beverage preparation device including such a fluid pulse damper. The disclosure enables the fluid passing into the fluid pulse damper to diffuse into a plurality of symmetrically distributed diversions, so that the energy is dispersed in the diversions with different directions, and then converges in proximity of the outlet. The energies of the diversions in opposite directions cancel each other's at the time of convergence, to obtain a smoother fluid flowing out from thereof.

### TECHNICAL FIELD

The present disclosure relates to the field of catering automation and, more specifically, to fluid pulse dampers used in automatic fluid dispensing. The present disclosure also relates to beverage preparation devices having such fluid pulse damper.

### BACKGROUND

As the standard of living improves, the demand for and consumption level of beverages is also rising, making ready-made beverage shops one of the fast-growing industries. Ready-made beverage shops can be found everywhere, and the hot scene of queuing is often seen.

Ready-made beverages require the ingredients having various flavors to be dispensed into packaged cups via a dispensing device and then distributed to consumers. In order to increase the efficiency of beverage dispensing, existing fluid dispensing devices typically pump the ingredient liquid through a fluid pump. When dispensing the beverage, due to the pumping force of the pump, a large amount of ingredient liquid will instantly gush out, thereby causing splashing, and the ingredient liquid may require intermittent multiple dispensing of the fluid pump, thereby generating pulses in the ingredient liquid, resulting in uneven pumping of the fluid and causing inconvenience for the on-site making of the beverage. Additionally, the flow rate of the pumping cannot be measured. And the hygiene of the dispensing operation environment is affected.

### SUMMARY

It is an object of the present disclosure to provide a fluid pulse damper and a beverage preparation device including the fluid pulse damper to solve or at least partially alleviate the above problem.

According to an aspect of the present disclosure, there is provided a fluid pulse damper comprising: a damper body and a top cover, the top cover being combined with the damper body to define a closed chamber, with an inlet and an outlet into the closed chamber provided at opposite ends of the damper body; and a damper block, being provided on a bottom wall of the closed chamber, and being shaped so that fluid entering from the inlet is divided into a number of diffuse diversions and the diffuse diversions converge in proximity to the outlet and then flow out from the outlet.

Preferably, the longitudinal cross-section of the damper body is rectangular, and the longitudinal profile cross-section of the damper block is a heart-shaped shape with a pointed tip towards the inlet, such that the damper block and the side wall of the closed chamber form two pathways from the inlet to the outlet.

Preferably, the longitudinal section of the closed chamber has a heart-shaped shape with a pointed tip towards the inlet, and the longitudinal profile section of the damper block also has a heart-shaped shape with a pointed tip towards the inlet, similar to the shape of the closed chamber, but with a size smaller than that of the closed chamber, so that the damper block and the sidewall of the closed chamber form two pathways from the inlet to the outlet.

Preferably, the middle part of the heart-shaped damper block is formed with a pathway from the inlet to the outlet, such that the closed chamber is formed three pathways from the inlet to the outlet by the damper block.

Preferably, a sealing membrane is provided between the upward opening of the damper body and the upper cover.

Preferably, the sealing membrane is a flexible membrane.

Preferably, a cushioning space is formed between the sealing membrane and the upper cover.

According to another aspect of the present disclosure, there is also provided a beverage preparation device in which a fluid pulse damper as described in any one of the above paragraphs is provided in the delivery pipe between dispensing port and the delivery pump, whereby the beverage dispensed into the beverage cup can be made to be more gently dispensed, and the splashing of the ingredient is reduced.

The advantage of the fluid pulse damper provided by the present disclosure is that the fluid entering the damper body is divided into a number of symmetrically distributed diffused diversions by means of a damper block provided on the bottom wall of the closed chamber, whereby the energy of the incoming fluid is dispersed in the diversions with different directions, and then the diffused diversions converge in proximity to the outlet, and after convergence they flow out from the outlet. In such way, the energy in the diversions in opposite directions cancels each other at the time of convergence, thereby obtaining a smooth outflow fluid. And further, by providing a flexible sealing membrane between the upward opening of the damper body and the upper cover, the cancelled energy can be released, thereby obtaining a smoother outflow fluid.

### BRIEF DESCRIPTION OF FIGURES

Other features, objects and advantages of the present disclosure will become more apparent by reading the detailed description of the non-limiting embodiments with reference to the following accompanying drawings:

FIG. 1 is a top view of an embodiment of the fluid pulse damper of the present disclosure, in which the top cover is removed for clarity.

FIG. 2 is a top view of the fluid pulse damper of FIG. 1 with the top cover installed.

FIG. 3 is a side view of a section taken along A-A in FIG. 2.

FIG. 4 is a top view of another embodiment of the fluid pulse damper of the present disclosure in which the top cover is removed.

FIG. 5 is a top view of the fluid pulse damper of FIG. 4 with the top cover installed.

FIG. 6 is a side view of a section taken along B-B in FIG. 5

### DETAILED DESCRIPTION

The present disclosure is further described in detail below in connection with the accompanying drawings and embodiments. It is to be anticipate that the specific embodiments described herein are only for the purpose of explaining the present disclosure and are not a limitation. It is also to be noted that, for ease of description, only the portions relevant to the present disclosure are shown in the accompanying drawings.

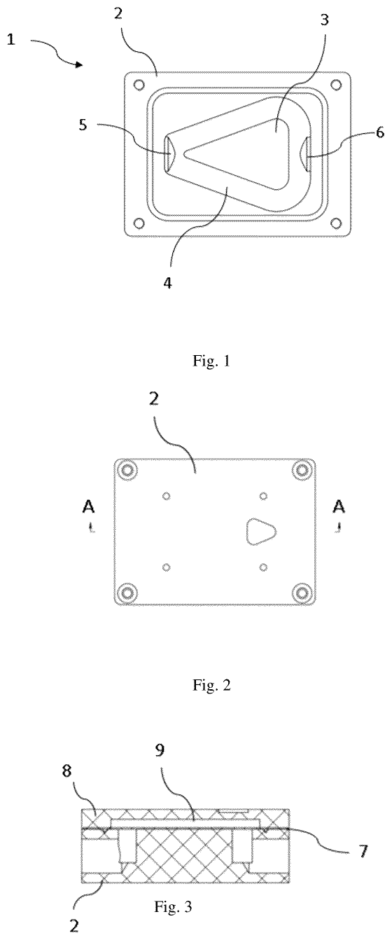

FIG. 1 is a top view of an embodiment of the fluid pulse damper of the present disclosure, in which the top cover and sealing membrane have been removed for clarity. FIG. 2 is a top view of the fluid pulse damper of FIG. 1, in which the top cover is installed. FIG. 3 is a sectional side view taken along A-A in FIG. 2.

As shown in FIG. 1, the fluid pulse damper 1 includes a damper body 2 and a top cover 7, which is removed for ease of illustration. The top cover 7 defines a closed chamber when incorporates with the damper body 2. An inlet 5 and an outlet 6 leading into the closed chamber are provided at opposite ends of the damper body 2. Fluid can enter from the inlet 5, pass through the closed chamber, and then flow out of the outlet 6.

A damper block 3 is provided on the bottom wall of the closed chamber. The damper block 3 may be shaped such that the fluid entering from the inlet 5 is divided into a number of diffused diversions, and the diffused diversions converge in proximity to the outlet 6, and then flow out of the outlet 6.

In this embodiment, the damper block 3 divides the fluid entering from the inlet 5 into two symmetrically diffused diversions, whereby the energy of the incoming fluid is dispersed in the two diffused diversions, which then converge in proximity of the outlet. In other words, the damper block 3 divides the closed chamber into two diffusion pathways, and the fluid entering the closed chamber is divided into two symmetrical, diffused diversions having opposite directions at the convergence, whereby the energy of the entering fluid is dispersed in the two diversions. And at the same time, the two diffusion pathways converge again in proximity to the outlet 6, so that the energies of the diversions of the opposite directions flowing out of the two pathways cancel each other out at the convergence. The total energy of the converging fluids thus is reduced, and ultimately a smooth fluid flowing out of the outlet 6 is formed.

And preferably, the longitudinal cross-section of the damper body 2 is rectangular, as shown in FIG. 1, so as to facilitate machining. The longitudinal profile cross-section of the damper block 3 is of a heart-shaped shape with a pointed tip towards the inlet 5, so that the damper block 3 and the side wall of the closed chamber form two pathways 4 from the inlet 5 to the outlet 6. As can be seen in the figure, the two pathways 4 are two diffuse pathways separated from the inlet 5 and turning in opposite directions to converge together in proximity to the outlet 6.

Referring again to FIGS. 2 and 3, it can be clearly seen that the damper body 2 in combination with the top cover 7 defines a closed space. The damper block 3 is provided on the bottom wall of the enclosed chamber. Optionally, the damper block 3 may be integrally formed with the damper body, or the both may also be secured together by other suitable means, such as bonding, fastener connection and the like.

Furthermore, a sealing membrane 6 is provided between the damper body 2 and the upper cover 7. Preferably, the sealing membrane 6 is a flexible membrane. A cushioning space 8 is provided between the flexible sealing membrane 6 and the upper cover 7. The collaboration configuration of the flexible sealing membrane 6 and the cushioning space 8 further releases the energy after the diffused diversions converged. The fluid flowing out of the outlet 6 is more gentle.

Optionally, the longitudinal cross-section of the closed chamber of the damper body has a heart-shaped shape with the pointed tip towards the inlet. The longitudinal profile cross-section of the damper block also has a heart-shaped shape with the pointed tip towards the inlet, which is similar to the shape of the closed chamber, but smaller in size than that of the closed chamber, so that the damper block and the side wall of the closed chamber form two diffused paths with equal cross sections from the inlet to the outlet. Such a configuration also cushions the fluid energy and creates a smooth, uniform outflow of fluid.

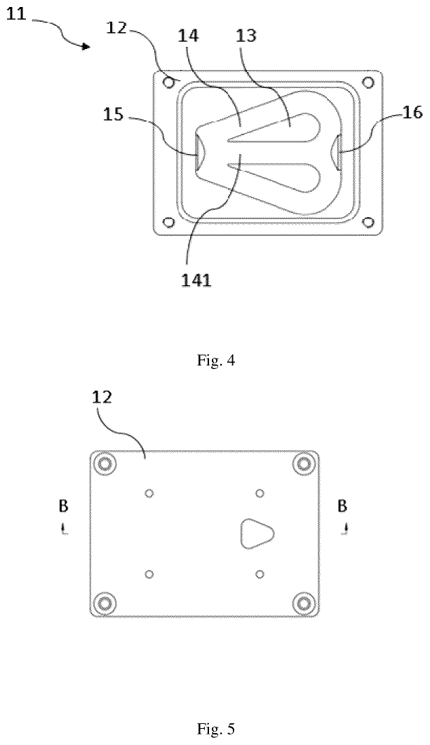

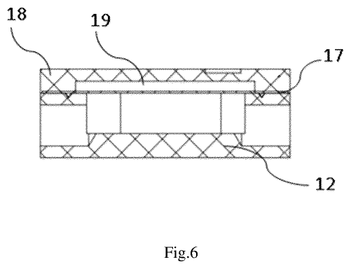

FIG. 4 is a top view of another embodiment of the fluid pulse damper of the present disclosure, in which the top cover and the sealing membrane have been removed for case of illustration. FIG. 5 is a top view of the fluid pulse damper of FIG. 4 with the top cover installed. FIG. 6 is a sectional side view taken along B-B in FIG. 5.

As shown in FIG. 4, the exemplary fluid pulse damper 11 includes a damper body 12 and a top cover 17, which is removed for case of illustration. The top cover 17 defines a closed chamber when combined with the damper body 12. An inlet 15 and an outlet 16 opening into the closed chamber are provided at opposite ends of the damper body 12. Fluid can enter from the inlet 15, pass through the closed chamber, and flow out of the outlet 16.

A damper block 13 is provided on a bottom wall of the closed chamber. The damper block 13 may be shaped such that the fluid entering from the inlet 15 is divided into a number of diffused diversions, and the diffused diversions converge in proximity to the outlet 16 and then flow out of the outlet 16.

In this embodiment, the damper block 13 divides the fluid entering from the inlet 15 into three symmetrically diffused diversions, whereby the energy of the incoming fluid is also dispersed among the three diffused diversions, and the three diversions then converge near the outlet. That is, the damper block 13 divides the closed chamber into three diffused pathways, and the fluid entering the closed chamber is divided into three symmetrical, diffused diversions by the three diffusion pathways, including two diversions having opposite directions at the convergence on the sides. Thereby, the energy of the incoming fluid is dispersed among the three diversions. And the three diffused pathways are then converged again in proximity to the outlet 16, so that energy of the diversions of opposite directions exiting on two sides is dispersed in the confluence, and the energy of the diversions of opposite directions is dispersed in the confluence, and then the three diversions merge again in proximity to the outlet. The energy of the diversions in the two pathways on sides in opposite directions cancels each other at the time of confluence, so that the total energy of the confluent fluid is lowered, and a smooth fluid flowing out of the outlet 16 is ultimately obtained. Preferably, as shown in FIG. 4, the longitudinal profile cross-section of the damper body 12 may be rectangular so as to facilitate machining. The longitudinal profile cross-section of the damper block 13 is in the shape of a heart with a pointed tip towards the inlet 15, so that the damper block 13 and the side wall of the closed chamber form two pathways 14 diffusing from the inlet 15 to the outlet 16. In this embodiment, as shown, the middle of the heart shaped damper block 13 is also formed with an intermediate pathway 141 from the inlet 15 to the outlet 16. In such way, the damper block 13 forms the closed chamber into three pathways from the inlet 15 to the outlet 16. Moreover, as shown, the three pathways split into three diffusion pathways from the inlet 15 and converge together in proximity to the outlet 16.

Such a configuration is advantageous for the reason that by the three diffusion pathways the incoming fluid is diverted to obtain three diffusion diversions, and at the same time the energy of the incoming fluid is dispersed among the three diversions. Each of diversions has a somewhat smaller amount of energy than the energy of the incoming fluid, and the diversions on each side have opposite directions, and the energies of the diversions having opposite directions also cancel each when the two diversions converge near the outlet. Thus, the energy of the final outflow fluid can be lowered and the outflow fluid can be smoother.

Referring again to FIGS. 5 and 6, it can be seen that the damper body 12 defines a closed space when combined with the top cover 17. The damper block 13 is provided on the bottom wall of the closed chamber. Optionally, the damper block 13 may be integrally formed with the damper body, or the both may also be secured together by other suitable means, such as bonding, fastener connection and the like.

Furthermore, a sealing membrane 16 is also provided between the damper body 12 and the upper cover 17. Preferably, the sealing membrane 16 is a flexible membrane. A cushioning space 18 is provided between the flexible sealing membrane 16 and the upper cover 17. The combined setting of the flexible sealing membrane 16 and the cushioning space 18 releases energy that is cancelled by the convergence of the diffused diversions, resulting in a smoother flow of fluid out of the outlet 16.

Also optionally, the longitudinal cross-section of the closed chamber of the damper body has a heart-shaped shape with the pointed tip towards the inlet, and the longitudinal profile cross-section of the damper block also has a heart-shaped shape with the pointed tip towards the inlet, similar to the shape of the closed chamber, but smaller in size than the closed chamber, such that the damper block and the sidewall of the closed chamber form two pathways of equal cross-section from the inlet to the outlet. Further, an intermediate pathway from the inlet to the outlet is formed in the middle of the heart-shaped damper block. Such a configuration likewise buffers the fluid energy and creates a smooth, uniform outflow fluid.

Theoretically, the number of symmetrically disposed diffusion pathways the fluid pulse damper of the present disclosure is not limited to two or three as described in the above embodiment, but may be more, without being limited by space.

The fluid pulse damper of the present disclosure can be used in a variety of applications. For example, it can be used in a beverage preparation device.

Specifically, the fluid pulse damper can be used in a dispensing device of a beverage preparation device, for example in a delivery pipe provided between a dispensing outlet and a delivery pump. Advantageously, the fluid pulse damper may be provided in a delivery pipe adjacent to the dispensing outlet. The fluid pulse damper, for example, divides the feed liquid flowing into its inlet into two or three diffusion diversions and, after converging in proximity to its outlet, then flows out of the fluid pulse and flows into the dispensing outlet for dispensing into beverage cups. As a result of the provision of the fluid pulse damper of the disclosure, a smoother distribution of the liquid is obtained and splashing of the liquid is prevented.

The above description is only a preferred embodiment of the present disclosure and an illustration of the technical principles utilized. It should be understood by those skilled in the art that the scope of the present disclosure is not limited to the technical solution formed by a specific combination of the above technical features, but also covers other technical solutions formed by any combination of the above technical features or their equivalent features, without departing from the concept of the present disclosure mentioned above. For example, a technical solution formed by interchanging the above features with (but not limited to) technical features having similar functions disclosed in the present disclosure.

1. A fluid pulse damper, comprising:
a damper body and a top cover, the top cover being combined with the damper body to define a closed chamber, with an inlet and an outlet into the closed chamber provided at opposite ends of the damper body; and
a damper block, being provided on a bottom wall of the closed chamber, and being shaped so that fluid entering from the inlet is divided into a number of diffuse diversions and the diffuse diversions converge in proximity to the outlet and then flow out from the outlet.

2. The fluid pulse damper of claim 1, wherein the longitudinal cross-section of the damper body is rectangular, and the longitudinal profile cross-section of the damper block is a heart-shaped shape with a pointed tip towards the inlet, such that the damper block and the side wall of the closed chamber form two pathways from the inlet to the outlet.

3. The fluid pulse damper of claim 1, wherein the longitudinal section of the closed chamber has a heart-shaped shape with a pointed tip towards the inlet, and the longitudinal profile section of the damper block also has a heart-shaped shape with a pointed tip towards the inlet, similar to the shape of the closed chamber, but with a size smaller than that of the closed chamber, so that the damper block and the sidewall of the closed chamber form two pathways from the inlet to the outlet.

4. The fluid pulse damper according to claim 3, wherein the middle part of the heart-shaped damper block is formed with a pathway from the inlet to the outlet, such that the closed chamber is formed three pathways from the inlet to the outlet by the damper block.

5. The fluid pulse damper of claim 1, wherein a sealing membrane is provided between the upward opening of the damper body and the upper cover.

6. The fluid pulse damper of claim 5, wherein the sealing membrane is a flexible membrane.

7. The fluid pulse damper of claim 6, wherein a cushioning space is formed between the sealing membrane and the upper cover.

8. A beverage preparation device, wherein a fluid pulse damper according to claim 1 is provided in the delivery pipe between the dispensing port and the delivery pump.
